(19) United States
(12) Patent Application Publication
(10) Pub. No.: US 2024/0428290 A1
(43) Pub. Date: Dec. 26, 2024

(54) MULTIDIMENSIONAL TESTING FOR MARKETING ANALYSIS

(71) Applicant: QSIC PTY LTD, Victoria (AU)

(72) Inventors: Matthew Elsley, Abbotsford (AU); Stefan Maetschke, Abbotsford (AU); Gerard Smith, Abbotsford (AU); Nicholas Larkins, Abbotsford (AU)

(21) Appl. No.: 18/702,593

(22) PCT Filed: Oct. 22, 2022
(86) PCT No.: PCT/AU2022/051272

§ 371 Date: Apr. 18, 2024

(30) Foreign Application Priority Data
Oct. 22, 2021 (AU) 2021903396

(51) Int. Cl. G06Q 30/0242; G06Q 30/0241

(52) U.S. Cl. CPC G06Q 30/0243; G06Q 30/0247

(57) ABSTRACT

The system and method provide automated scheduling, monitoring and evaluation of repeated, alternating set of A/B tests arranged in a multidimensional pattern (hypercube). It provides a robust system and method for computationally repeated A/B testing while enabling easy adjustment of statistical power and other parameters. The statistical power of the system and method can be increased by increasing the number of repeated A/B tests over time. Furthermore, the system and method enables axis-wise (hypercube) evaluation of tests which allows comparison of the impact of creative content on different variables.

### BACKGROUND OF THE INVENTION:

A/B testing is an experimental method to test the impact of a variable on a metric. For instance, one can test whether (A) playing an audio advertisements (variable) results in an increase of sales (metric) compared to (B) not playing the advertisement. Classical A/B testing considers only a single variable, while A/B/n or multivariate testing considers many variables and is specifically concerned about efficient testing regimes.

A/B testing requires that the populations underlying the testing of variant A or variant B are comparable; otherwise the test result might be skewed. For example, if an ad is played in. store A but not in store B, but store B generally sells more products, the benefit of advertising may not be detectable, since the sales of store A remain lower than B-despite advertising.

Instead of testing A and B on two different stores, the weekly sales volume for a single store could be recorded and the results for a week with advertising (A) could be compared to a week without advertising (B). The problem remains, however, since a general trend in sales (decreasing, increasing over time) can skew the test result in the same way as a split over stores.

Traditionally, A/B testing therefore operates on large numbers of randomly selected users, stores or generally “subjects” to mitigate potential skewing of test results due to heterogeneous population in A and B splits, and the statistical significance of the test is based on the difference between the means of the populations and their standard deviations.

The reference to any prior art in this specification is not, and should not be taken as, an acknowledgement or any form of suggestion that the prior art forms part of the common general knowledge.

### SUMMARY OF THE INVENTION:

The system and method of the invention provide automated scheduling, monitoring and evaluation of repeated, alternating set of A/B tests arranged in a multidimensional pattern (hypercube). It provides a robust system and method for computationally repeated A/B testing while enabling easy adjustment of statistical power and other parameters. The statistical power of the system and method can be increased by increasing the number of repeated A/B tests over time. Furthermore, the system and method enables axis-wise (hypercube) evaluation of tests which allows comparison of the impact of creative content on different variables.

According to the present invention, the impact of a creative (such as an audio or visual advertisement or a piece of music) on a business metric (such as sales volume, sales variance, revenue, basket size, number of customers or customer retention) can be measured with predetermined confidence on a small number of variants of a variable (for example stores or locations) by employing a repeated, alternating pattern of A/B tests.

The system and method of the invention is more robust to confounding external factors, such as weather, holidays, or other events that affect the chosen metric, compared to the traditional A/B test for a small number of variants.

The statistical power of the test system of the present invention can be readily increased easily by extending the test time (increasing the number of repeated A/B tests). This is in contrast to the traditional approach, in which statistical power is increased by increasing the number of stores participating in the test. Usually it is however more expensive to run an A/B test over more stores compared to running an A/B test longer, especially when the A/B test requires the installation of required hardware, such as audio systems, for instance.

Throughout this specification (including any claims which follow), unless the context requires otherwise, the word ‘comprise’, and variations such as ‘comprises’ and ‘comprising’, will be understood to imply the inclusion of a stated integer or step or group of integers or steps but not the exclusion of any other integer or step or group of integers or steps.

### BRIEF DESCRIPTION OF THE DRAWINGS:

FIG. 1 is simple diagram to illustrate A/B testing.

FIG. 2 is a simple chart showing how probabilities are determined for the chart in FIG. 1.

FIG. 3 is a simple chart showing A/B testing over 4 time periods, for example 4 weeks.

FIG. 4 is a simple table showing A/B testing over 5 time periods, for example 5 weeks for 4 variables (example locations/stores).

FIG. 5 is a graphical illustration of the effect of combing A/B testing across three variables—in this case, products, stores and weeks.

FIG. 6 is a chart showing the components of an example system according to the invention.

FIG. 7 is a flow chart showing an example process flow for an example system according to the invention.

FIG. 8 depicts an example report produced according to one example implementation of the invention.

FIG. 9 depicts an example checkerboard pattern report produced according to one example implementation of the invention.

FIG. 10 shows an example 90% confidence interval for the products across multiple stores produced according to one example implementation of the invention testing sales quantity caused by predetermined advertisements.

### DETAILED DESCRIPTION OF EXEMPLARY EMBODIMENTS

It is convenient to describe the invention herein in relation to particularly preferred embodiments. However, the invention is applicable to a wide range of embodiments and it is to be appreciated that other constructions and arrangements are also considered as falling within the scope of the invention. Various modifications, alterations, variations and or additions to the construction and arrangements described herein are also considered as falling within the ambit and scope of the present invention.

The invention provides a computer implemented marketing analysis system comprising: a networked server to render an interface, the interface comprising: a plurality of selectable variables; a plurality of selectable items of creative content; a plurality of selectable metrics; an experiment generator to receive from the server one or more inputs associated with the selectable variables, selectable creative content and/or selectable metrics and construct an n-dimensional data structure; each selectable geographic location comprising: an audio and/or visual device; and an information gathering device a scheduler to receive the data structure and retrieve data associated with the selected creative content from a database, the scheduler in communication with the audio and/or visual devices so as to control such device(s) to present the creative content according to the data structure; a tracker to receive information from the information gathering device and record a metric of interest over time in a results database.

The invention also provides a computer implemented marketing analysis system comprising: a networked server to render an interface, the interface comprising: a plurality of selectable variables comprising one or more of time, geographic location and product; a plurality of selectable items of creative content; a plurality of selectable metrics; an experiment generator to receive from the server one or more inputs associated with the selectable variables, selectable creative content and/or selectable metrics and construct an n-dimensional data structure; each selectable geographic location comprising: an audio and/or visual device; and an information gathering device a scheduler to receive the data structure and retrieve data associated with the selected creative content from a database, the scheduler in communication with the audio and/or visual devices so as to control such device(s) to present the creative content according to the data structure; a tracker to receive information from the information gathering device and record of a metric of interest over time in a results database.

The information gathering device may for example be one or more of a point of sale system to monitor a point of sale metric; and a sensor to measure one or more metrics which may be proxy-metrics. (A proxy-metric is information that indicates the value of another metric, for example if that second metric is more difficult to directly measure.)

The invention also provides a computer implemented marketing analysis system comprising: a webserver to render a web interface, the web interface comprising: a plurality of selectable variables comprising a geographic location and one or more of a product; a plurality of selectable items of creative content; a plurality of selectable metrics; an experiment generator to receive from the webserver one or more inputs associated with the selectable variables, selectable creative content and/or selectable metrics and construct an n-dimensional data structure; each selectable geographic location comprising: an audio and/or visual device; a point of sale system to monitor a point of sale metric; optionally one or more sensors to measure one or more proxy-metrics such as in-store noise, foot-traffic; a scheduler to receive the data structure and retrieve data associated with the selected creative content from a database, the scheduler in communication with the audio and/or visual devices so as to control such device(s) to present the creative content according to the data structure; a tracker to receive point of sale data (and optionally sensor data) and record a metric of interest over time in a results database; an evaluator service to retrieve the results stored in the results database and the A/B testing schedule specified by the data structure and compute a report; a reporter to make the report available to a user.

The invention is also a computer implemented marketing analysis system comprising: a webserver to render a web interface, the web interface comprising: a plurality of selectable variables comprising one or more of time, geographic location, product, a plurality of selectable items of creative content comprising one or more of audio advertisement(s); visual advertisement(s); and music; a plurality of selectable metrics comprising one or more of sales volume, sales variance, revenue, basket size, number of customers and customer retention; an experiment generator to receive from the webserver one or more inputs associated with the selectable variables, selectable creative content and/or selectable metrics and construct an n-dimensional data structure comprising a hyper-cuboid of repeated, alternating A/B tests to conduct, wherein an A/B test is the playing or not-playing of selected creative content at a selected time and/or location for a given product and the axes of the hyper-cuboid are the variables selected by the user, such as stores, time periods (such as weeks) and/or products and wherein the cells of the hyper-cuboid comprise one or more of a list of advertisements to play or boolean flags, comprising True or False, which indicate whether an item of creative content is played/displayed or not for a specific week, store and/or product; each selectable location comprising: an audio and/or visual device; a point of sale system to monitor one or more of sales volume, sales variance, revenue, basket size, number of customers or customer retention; optionally one or more sensors to measure one or more proxy-metrics such as in-store noise, foot-traffic; a schedular to receive the hyper-cuboid data and retrieve data associated with the selected creative content from a database of music and audio ads, the scheduler in communication with the audio and/or visual devices so as to control such device(s) to present the creative content according to the hyper-cuboid data; wherein, if a cell for specific time, store and/or product contains the value is true the creative is played/displayed, otherwise it is not; a tracker to receive point of sale data (and optionally sensor data) and record a metric of interest over time in a results database; an evaluator servicer to retrieve the results stored in the results database and the A/B testing schedule specified by the hyper-cuboid and compute a report; a reporter to make the report available to a user via one or more of a web interface, an email, a hard copy or SMS.

The invention is also a computer implemented marketing analysis method comprising: receiving via a web interface one or more inputs from a user in relation one or more selectable variables, selectable items of creative content and selectable metrics; constructing an n-dimensional data structure comprising a hyper-cuboid of repeated, alternating A/B tests to conduct, running A/B tests by presenting the creative content in accordance with the data structure; receiving, recording and tracking data associated with one or more metrics associated with the data structure; generating a report for presentation to a user.

The invention is also a computer implemented marketing analysis method comprising: rendering from a networked server, an interface, the interface comprising: a plurality of selectable variables comprising one or more of time, geographic location and product; a plurality of selectable items of creative content; a plurality of selectable metrics; receiving from the server one or more inputs associated with the selectable variables, selectable creative content and/or selectable metrics and construct an n-dimensional data structure; each selectable geographic location comprising: an audio and/or visual device; and an information gathering device; receiving the data structure and retrieving data associated with the selected creative content from a database, the scheduler in communication with the audio and/or visual devices so as to control such device(s) to present the creative content according to the data structure; receiving information from the information gathering device and record a metric of interest over time in a results database.

The marketing analysis system of the invention may be used in a wide variety of situations, for example to improve understanding of a selected marketing and sales environment and therefore better understand various social and psychological factors and for example improve sales and profitability.

The server may render any form of interface suitable for a user to receive and input information relevant to the analysis at hand. The server must be able to communicate with other elements of the system, for example via a network. In some preferred embodiments, the network is a global communications network such as the internet. In some preferred embodiments, the server is a webserver and the interface is a web interface.

The variables which are selectable via the interface may be of any type suitable for marketing analysis. For example, they may relate to cost, price, time, a location, a geographic location, a product, a product category, positioning of a product, target audience, people, packaging, etc.

The items of creative content may be of any type suitable to influence a marketing outcome. In some preferred embodiments they comprise audio or visual marketing or advertisements or music. They may also for example comprise other treatments of the environment such as music, video entertainment, pre-recorded sounds, smells (for example that stimulate hunger), tactile offerings, and so on. The creative content may be stored and or deployed remotely or at the geographical location of interest. For example, audio or video content may be electronically stored at a server and transmitted to the location on demand, or it may be stored locally and played when instructed. Other sensory content which is not capable of being digitally transmitted (such as smell or tactile content) will be stored locally but may be triggered to be displayed remotely.

The metrics may be of any suitable type which will inform a marketing analysis according to the invention. For example, they may comprise sales, sales volume, sales growth, sales variance, revenue, profit, leads, value of a customer, lifetime value of a customer, return on investment, cost of customer acquisition, sales team response time, traffic at a location, net promoter score, basket size, amount spent per customer or type of customer, number of customers, customer retention and so on.

The experiment generator receives from the server one or more inputs associated with the selectable variables, selectable creative content and/or selectable metrics and constructs an n-dimensional data structure comprising a hyper-cuboid of repeated, alternating A/B tests to conduct, wherein an A/B test is the playing or not-playing of selected content at a selected time and/or location for a given product and the axes of the hyper-cuboid are the variables selected by the user as above. In some embodiments, the cells of the hyper-cuboid comprise one or more of a list of content options to play or display or for example boolean flags, comprising True or False, which indicate whether an item of content is played/displayed or not for a specific time, store and/or product etc.

Each of the geographic locations comprise a device to display or play selected content. The device may be of any suitable type to play or display the content of interest, for example audio speakers, video displays, smell generators or tactile displays.

The information gathering device may be of any type suitable to gather meaningful information for the marketing analysis. For example, it may comprise a point of sales system (to gather sales metrics as discussed above), or one or more sensors to gather local sensed data for example as proxy metrics. Sensors may be of any type suitable to gather information useful for the marketing analysis which may for example be used as proxy-metrics. These may for example comprise microphones to sense in-store noise, or foot-traffic, vibration sensors to sense foot traffic, video cameras to analyse video footage and count store users and for example analyse their behaviour.

The schedular receives the hyper-cuboid data and retrieves data associated with the selected content from a database of content database. The scheduler is in communication with the content device(s) so as to control such device(s) to present the content according to the hyper-cuboid data. The schedular may communicate with the content devices in any manner suitable to facilitate the invention. It may be wireless or physical, it may be a network such as a global communications network or a local area network, it may be direct, via a wireless protocol method such as Bluetooth, Zigbee etc.

In some preferred embodiments, if a cell in a cuboid for a specific time, store and/or product contains the value ‘True’ the content is played/displayed, otherwise it is not.

The tracker receives data (such as point of sale or sensor data) and records a metric of interest over time in a results database. The results database may be stored in any location which enables working of the invention. For example it may be on the server, or a separate server, or at a selected location, etc.

The evaluator service retrieves the results stored in the results database and the A/B testing schedule specified by the hyper-cuboid and computes a report. The report may be of any type and presented in any manner suitable to provide useful information about the analysis to a user.

The reporter makes the report available to a user. It can do so in any way suitable to enable the user to use the report and its information. For example, it may be via one or more of a computer interface, an email, SMS, hard copy, audio message etc.

The following description demonstrates certain preferred embodiments.

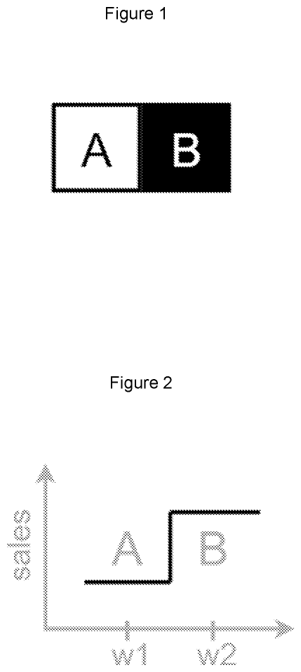

Referring to FIG. 1, the fundamental problem of A/B testing is that confounding factors can easily skew the test result. For instance, assuming an A/B test which compares the average sales volume of some product for week one (w1) to week two (w2) when playing an audio advertisement (B) or not playing the advertisement (A).

As depicted in FIG. 2, there are essentially two potential outcomes: the sales increase in week two or they don't. If we are ignoring the case that the sales are exactly the same in both weeks, which is of negligible probability for high volume products, the probability of the two outcomes is 50% as shown by the equation:

$$p ( B > A ) \approx \frac{1}{2} = 50 \%$$

Consequently, if the impact of advertising on weekly sales is low in comparison to the many other confounding factors such as weather, season, holidays, covid, other events that alter the sales, for example sporting events such as soccer matches and more, the test outcome is largely random and the impact of advertising nearly impossible to detect.

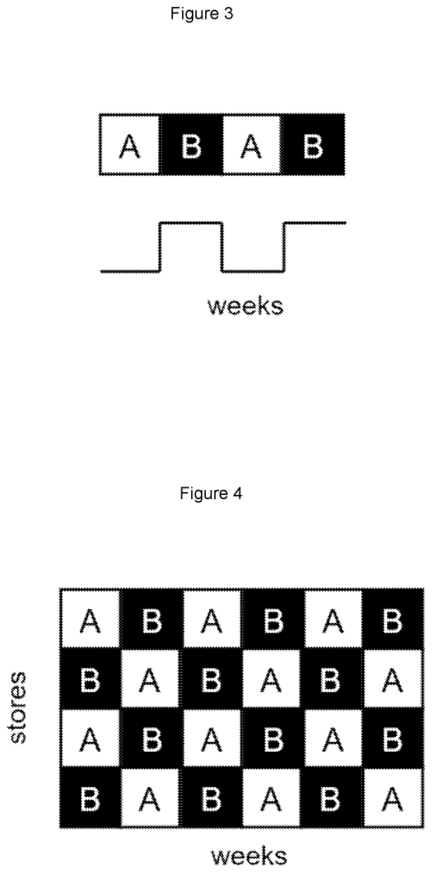

According to the invention, the problem can be overcome with a system and method of the invention, which enables carefully constructed and repeated A/B tests, over multiple periods of time (such as weeks) for example using an alternating A/B test pattern, for example as set out in FIG. 3 which shows a 4 week test pattern.

In this case, the probability of observing such a pattern by chance is only 12.5% compared to the 50% for a single A/B test, making it much more likely to detect the impact of an advertising campaign as set out in the formula:

$$p ( ) \approx \frac{1}{{2}^{3}} = \frac{1}{8} = 12.5 \%$$

Note that, by increasing the number of repetitions the probability of observing the alternating pattern by chance can be greatly reduced. This is beneficial, since extending the time for a test is relatively simple, while adding stores or products or other versions of variables to improve statistical power is time and cost consuming (additional hardware installations such as an audio system and/or additional creatives may be required).

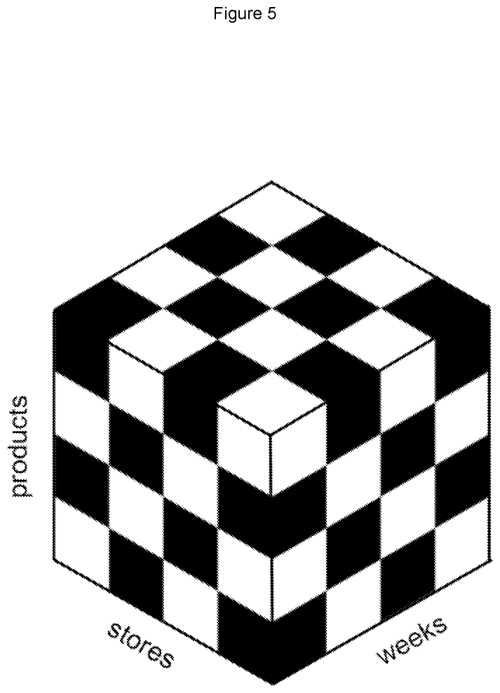

This novel approach of repeated, alternating A/B tests can be extended to multiple variants, resulting in a 2-dimensional, alternating grid (checkerboard), for example, for time periods (such as weeks) and locations (such as stores) as depicted in FIG. 4 or a 3-dimensional, alternating cuboid for time periods (such as weeks), locations (such as stores) and products as depicted in FIG. 5, or an n-dimensional hyper-cuboid, in general.

Note that it is also considered within the scope of the invention to repeat A/B tests but in a randomised, non-repeating pattern. Such embodiments are more computationally complex and in some circumstances can be difficult to interpret. In some embodiments, this may for example be ameliorated by performing a balancing process to ensure an equal number of each of the A and B alternatives.

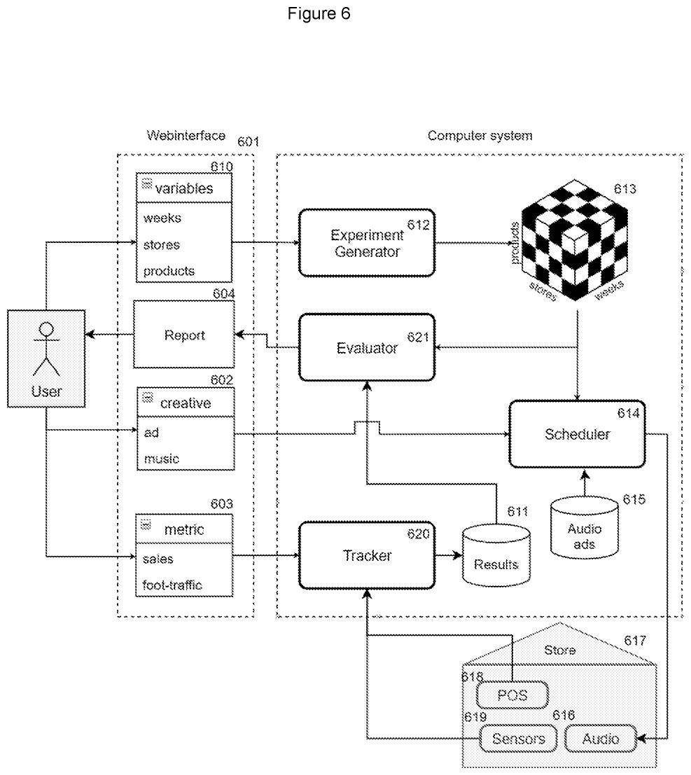

A chart setting out components of an example system according to the invention for repeated, alternating A/B testing of audio advertisements is depicted in FIG. 6. In this example, a web interface (601) running on a webserver displays a user interface where a user (e.g. store manager) selects which variables (610), such as weeks, stores, products to run an A/B test on. The user furthermore selects the creative content (602) such as audio ad, and/or ad display and/or music to play from a database (615) of available creatives and the metric (603) to evaluate, for example sales volume, sales variance, revenue, basket size, number of customers or customer retention.

The webserver sends the selected variables (for example as a list) to the experiment generator (612), which is a service that can for example be run on a computer system separate to the webserver but doesn't have to. The experiment generator constructs an n-dimensional data structure, a hyper-cuboid (613), of repeated, alternating A/B tests to conduct, wherein an A/B test is the playing or not-playing of the chosen creative content (eg. music), or showing or not-showing an electronic display, and/or playing or not playing an audio-ad within a specific store, for a given time and product. The axes of the hyper-cuboid are the variables selected by the user, such as stores, weeks and/or products. The cells for the hyper-cuboid are Boolean flags (True or False), which indicate whether a creative is played/displayed or not for a specific week, store and/or product. Alternatively, the cells may also contain for example a list of advertisements to play.

The hyper-cuboid data is fed to a scheduler (614), which reads the selected creative content from a database (615) of music, display text and audio ads. (It should be noted here that stores and dates are part (axes) of the hyper-cuboid, which is generated by the Experiment Generator, which itself receives this information via the webserver/web interface.) The scheduler controls the in-store audio equipment (e.g. Qbit) or display (e.g. video screen or electronic board) (616) via an internet connection (for example, via Rest API) which plays the creative content at the scheduled weeks/times, stores and/or products as specified by the axes and cells of the hyper-cuboid. Specifically, in one implementation, if a cell for a specific week, store and/or product contains the value ‘true’ then the creative is played/displayed, otherwise it is not. The creative content may for example be either transmitted electronically to the audio/display device in the store or the content may be preloaded for example on a device located at the store.

Physical stores (617) have audio equipment (616) (player, speaker, controller, for instance a Qsic Qbit device) to play audio content, a Point of Sales (POS) system (618) to monitor key information, such as sales volume, sales variance, revenue, basket size, number of customers or customer retention and potentially additional sensors (619) to measure other proxy-metrics such as in-store noise (AVA) or foot-traffic (XY-Sense). Sensors may also for example measure proxies for the originally intended metric. For instance, ambient noise detector signals (AVA) are correlated with in-store occupancy, or an x-y sensor may estimate foot-traffic.

POS (point of sale) (618) and sensor (619) data are sent to a tracker (620), which records the metric of interest over time in a results database (611), for instance an SQL database running on the computer system, while the scheduler (614), again a service running on a computer, executes the A/B tests specified by the hyper-cuboid (613).

The evaluator service (621) reads the results stored in the results database (611) and A/B testing schedule specified by the hyper-cuboid (613). It computes a report (604) that is made available to a user, for example displayed via a web interface to the user or can be sent via electronic means, such as email or SMS to a mobile device.

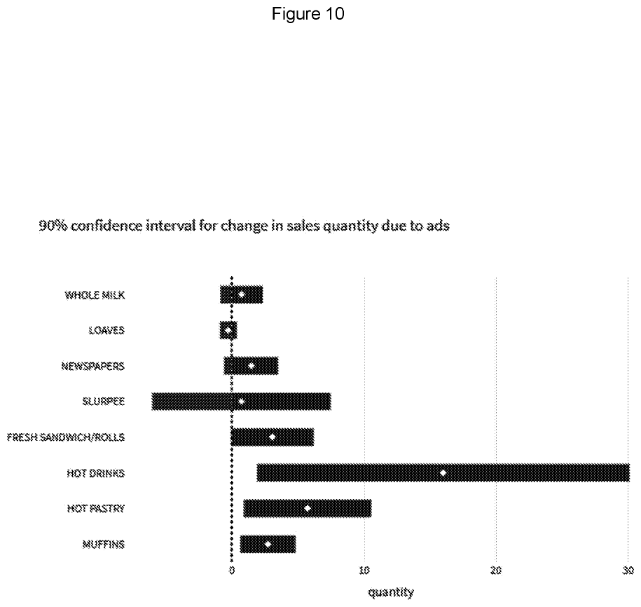

In this example embodiment, the report shows the statistical significance (confidence intervals) of the impact the creative content (ad-campaign) on the chosen metric for the selected products and/or stores (FIG. 10). In specific scenarios, e.g. when point of sales data (POS) is provided, the evaluator may for example estimate revenue increases associated with or driven by the creative.

Furthermore, the report may also contain the statistical significance along the different axes of the hyper-cuboid, which allows assessing the impact of advertising and/or music for stores or products independently (FIG. 10).

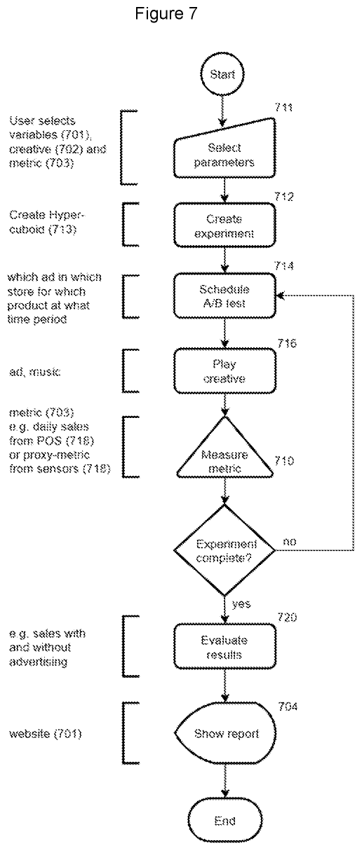

FIG. 7 is a flow chart showing an example process flow for an example system according to the invention. The user selects parameters such as variables (701), creative content (702) and metric (703) on a web interface (711). The experiment generator (712) then creates the hyper-cuboid (713) which specifies the A/B testing schedule that is executed by the scheduler (714). The scheduler (714) runs A/B tests until the experiment is complete. In each loop the scheduled creative content (702) is played on the in-store audio system (716) and the selected metric (703) is measured by the tracker (710); for example either based on POS (718) or sensor (719) data or optionally both. Once the experiment is complete (scheduled A/B tests are complete), the evaluator (720) creates a report. (704) which as described above, can be displayed to the user via the web interface (701).

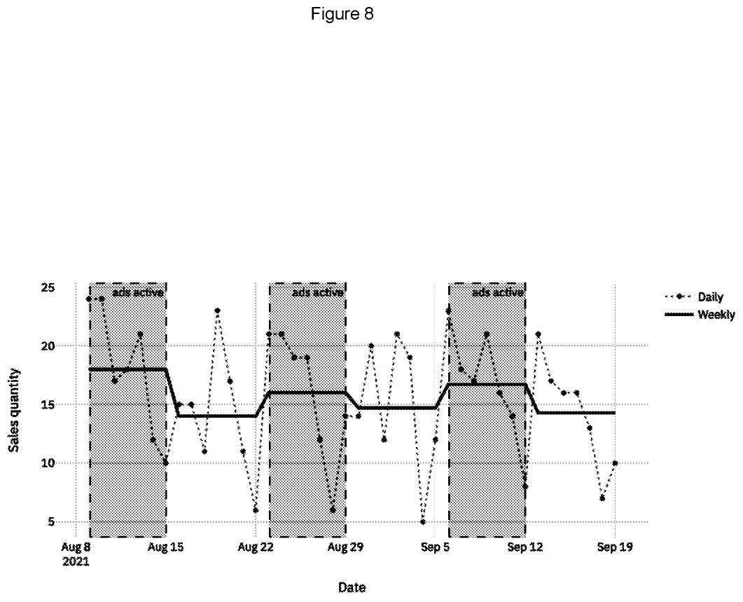

FIG. 8 depicts an example report produced according to one implementation of the invention. The report shows the daily sales (dashed line) of Muffins (product) with A/B testing of audio ads scheduled over four weeks. Areas labelled “ads active” mark the weeks in which ads were played. The weekly sales average (bold line) shows an increase when ads where played.

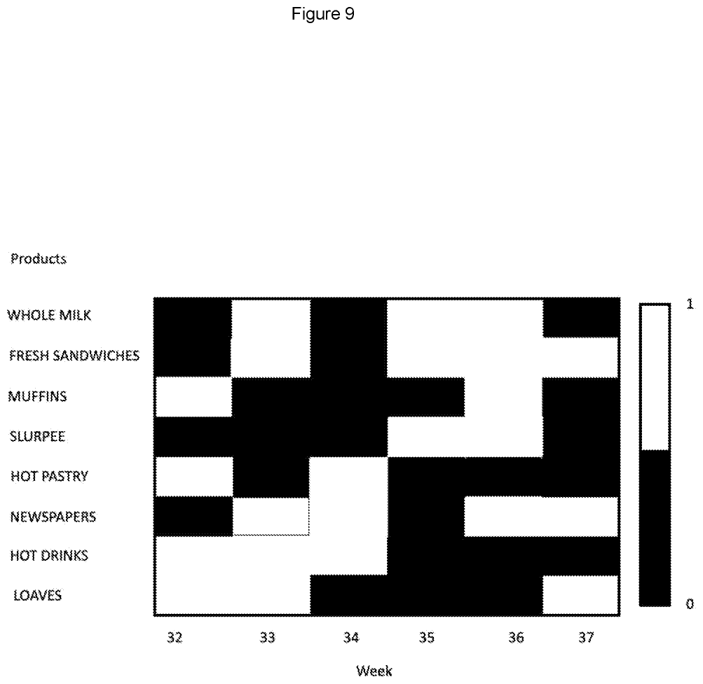

FIG. 9 shows the checkerboard pattern over a set of products (Milk, Sandwiches, Muffins, Slurpee, Hot pastry, Newspapers, Hot drinks and Loaves) and weeks (week 32-37). The grayscale indicates the normalized sales quantity of those products.

FIG. 10 shows the 90% confidence interval for the products across multiple stores. They contain the mean increase in revenue or sales quantity due to advertising and the lower and upper bounds of the confidence intervals describe the worst and best case scenarios with respect to expected ad revenue. These confidence intervals may be provided as part of the report.

1. A computer implemented marketing analysis system comprising:
a networked server to render an interface, the interface comprising:
a plurality of selectable variables;
a plurality of selectable items of creative content;
a plurality of selectable metrics;
an experiment generator to receive from the server one or more inputs associated with the selectable variables, selectable creative content and/or selectable metrics and construct an n-dimensional data structure;
each selectable geographic location comprising: an audio and/or visual device; and an information gathering device
a scheduler to receive the data structure and retrieve data associated with the selected creative content from a database, the scheduler in communication with the audio and/or visual devices so as to control such device(s) to present the creative content according to the data structure;
a tracker to receive information from the information gathering device and record a metric of interest over time in a results database.

2. A computer implemented marketing analysis system comprising:
a networked server to render an interface, the interface comprising:
a plurality of selectable variables comprising one or more of time, geographic location and product;
a plurality of selectable items of creative content;
a plurality of selectable metrics;
an experiment generator to receive from the server one or more inputs associated with the selectable variables, selectable creative content and/or selectable metrics and construct an n-dimensional data structure;
each selectable geographic location comprising: an audio and/or visual device; and an information gathering device
a scheduler to receive the data structure and retrieve data associated with the selected creative content from a database, the scheduler in communication with the audio and/or visual devices so as to control such device(s) to present the creative content according to the data structure;
a tracker to receive information from the information gathering device and record a metric of interest over time in a results database.

3. A system according to claim 1 wherein the information gathering device is optionally one or more of a point of sale system to monitor a point of sale metric; and a sensor to measure one or more proxy-metrics.

4. A computer implemented marketing analysis system comprising:
a webserver to render a web interface, the web interface comprising:
a plurality of selectable variables comprising one or more of time, geographic location and product;
a plurality of selectable items of creative content;
a plurality of selectable metrics;
an experiment generator to receive from the webserver one or more inputs associated with the selectable variables, selectable creative content and/or selectable metrics and construct an n-dimensional data structure;
each selectable geographic location comprising:
an audio and/or visual device;
a point of sale system to monitor a point of sale metric;
optionally one or more sensors to measure one or more proxy-metrics such as in-store noise, foot-traffic;
a scheduler to receive the data structure and retrieve data associated with the selected creative content from a database, the scheduler in communication with the audio and/or visual devices so as to control such device(s) to present the creative content according to the data structure;
a tracker to receive point of sale data (and optionally sensor data) and record a metric of interest over time in a results database;
an evaluator servicer to retrieve the results stored in the results database and the A/B testing schedule specified by the data structure and compute a report;
a reporter to make the report available to a user.

5. A computer implemented marketing analysis system comprising:
a webserver to render a web interface, the web interface comprising:
a plurality of selectable variables comprising one or more of time, geographic location, product,
a plurality of selectable items of creative content comprising one or more of audio advertisement(s); visual advertisement(s); and music;
a plurality of selectable metrics comprising one or more of sales volume, sales variance, revenue, basket size, number of customers and customer retention
an experiment generator to receive from the webserver one or more inputs associated with the selectable variables, selectable creative content and/or selectable metrics and construct an n-dimensional data structure comprising a hyper-cuboid of repeated, alternating A/B tests to conduct,
wherein an A/B test is the playing or not-playing of selected creative content at a selected time and/or location for a given product and the axes of the hyper-cuboid are the variables selected by the user, such as stores, weeks and/or products and wherein the cells of the hyper-cuboid comprise one or more of a list of advertisements to play or boolean flags, comprising True or False, which indicate whether an item of creative content is played/displayed or not for a specific week, store and/or product.
each selectable location comprising:
an audio and/or visual device;
a point of sale system to monitor one or more of sales volume, sales variance, revenue, basket size, number of customers or customer retention;
optionally one or more sensors to measure one or more proxy-metrics such as in-store noise, foot-traffic;
a schedular to receive the hyper-cuboid data and retrieve data associated with the selected creative content from a database of music and audio ads, the scheduler in communication with the audio and/or visual devices so as to control such device(s) to present the creative content according to the hyper-cuboid data;
wherein, if a cell for specific time, store and/or product contains the value is true the creative is played/displayed, otherwise it is not;
a tracker to receive point of sale data (and optionally sensor data) and record a metric of interest over time in a results database;
an evaluator servicer to retrieve the results stored in the results database and the A/B testing schedule specified by the hyper-cuboid and compute a report;
a reporter to make the report available to a user via one or more of a web interface, an email or SMS.

6. A computer implemented marketing analysis method comprising:
receiving via a web interface one or more inputs from a user in relation one or more selectable variables, selectable items of creative content and selectable metrics;
constructing an n-dimensional data structure comprising a hyper-cuboid of repeated, alternating A/B tests to conduct, running A/B tests by presenting the creative content in accordance with the data structure;
receiving, recording and tracking data associated with one or more metrics associated with the data structure;
generating a report for presentation to a user.

7. A computer implemented marketing analysis method comprising:
rendering from a networked server, an interface, the interface comprising:
a plurality of selectable variables comprising one or more of time, geographic location and product;
a plurality of selectable items of creative content;
a plurality of selectable metrics;
receiving from the server one or more inputs associated with the selectable variables, selectable creative content and/or selectable metrics and construct an n-dimensional data structure;
each selectable geographic location comprising: an audio and/or visual device; and an information gathering device
receiving the data structure and retrieving data associated with the selected creative content from a database, the scheduler in communication with the audio and/or visual devices so as to control such device(s) to present the creative content according to the data structure;
receiving information from the information gathering device and record a metric of interest over time in a results database.

8. A method according to claim 7, wherein the information gathering device is optionally one or more of a point of sale system to monitor a point of sale metric; and a sensor to measure one or more proxy-metrics.

9. A system according to claim 1, wherein the creative content is either transmitted electronically to the audio/display device at the selectable locations or preloaded for example on a device located at the location.

10. A method according to claim 7, wherein the creative content is either transmitted electronically to the audio/display device at the selectable locations or preloaded for example on a device located at the location.
